(19) United States
(12) Patent Application Publication
(10) Pub. No.: US 2022/0368987 A1
(43) Pub. Date: Nov. 17, 2022

(54) IMPROVEMENTS IN AND RELATING TO CONTENT IDENTIFICATION

(71) Applicant: CENSORPIC LTD, Edinburgh (GB)

(72) Inventor: Hannah Mercer, Edinburgh (GB)

(73) Assignee: DRAGONFLAI LTD, Edinburgh (GB)

(21) Appl. No.: 17/765,537

(22) PCT Filed: Dec. 6, 2019
(86) PCT No.: PCT/GB2019/053447

§ 371 Date: Mar. 31, 2022

(30) Foreign Application Priority Data
Oct. 2, 2019 (GB) 1914255.3

(51) Int. Cl. H04N 21/454; H04N 21/4545; G06V 10/764

(52) U.S. Cl. CPC H04N 21/4542; H04N 21/4545; G06V 10/764

(57) ABSTRACT

Online sharing of media containing inappropriate-content (e.g., explicit or otherwise inappropriate content) There is provided a method for controlling or preventing dissemination of explicit images or other content that may be flagged as inappropriate. The method comprises identifying and preventing display of flagged content on a user device, the user device having an image capture component and a display component. The method comprises: providing a screen projection of at least a first image frame captured by the image capture component to the display component, analysing the screen projection to detect the presence of flagged content, and interrupting the provision of the screen projection if flagged content is detected.

### FIELD OF THE INVENTION

This invention relates to identifying content on user devices and particularly, but not exclusively, identifying and preventing display of flagged content on user devices.

### BACKGROUND TO THE INVENTION

The use of online communications and media sharing is increasing, in particular between individuals. It is becoming commonplace for many individuals to share messages, images and other media with other individuals, e.g., friends, family or even strangers. This includes the sharing of images and other media with private or explicit content, e.g., images or media with pornographic content.

‘Sexting’ (i.e., sharing of explicit images via a messaging service) is an ever-increasing problem for children or teenagers. A study by the UK Government Children's Commissioner has revealed that 60% of teenagers have been asked for naked photos of themselves and that 40% of have taken nude ‘selfies’ (i.e., images of themselves). A further study, conducted by the UK National Society for the Prevention of Cruelty to Children, has found that, of children or teenagers that have sent nude selfies, 58% sent such images to a boyfriend or girlfriend. However, 1 in 3 respondents in the study stated that they had sent nude selfies to a person that they did not know.

Once an image has been shared by an originator (or has otherwise been transmitted from the originator's user device to a device not owned or controlled by the originator), it is nearly impossible to control or prevent further sharing or dissemination of the image. Given the potential negative consequences of explicit or otherwise controversial images, there is a need to control or prevent dissemination of images containing such content.

Given the challenges in controlling distribution of images or other materials, it may be may in some circumstances be preferable to prevent such images or media from being obtained in the first place. This can be done either as an alternative or in addition to the distribution of such images. There is, therefore a need to control or otherwise prevent images or media from being obtained.

The inventor has appreciated the shortcomings of existing technologies in this field.

### SUMMARY OF THE INVENTION

In accordance with a first aspect of the invention, there is provided a method for identifying and preventing display of flagged content on a user device, the user device having an image capture component and a display component, the method comprising:
providing a screen projection of at least a first image frame captured by the image capture component to the display component;
analysing the screen projection to detect the presence of flagged content; and
interrupting the provision of the screen projection if flagged content is detected.

The step of analysing the screen projection may comprise:
identifying a screen classification of the screen projection; and
comparing the identified screen classification with a set of flagged classifications.

The step of analysing the screen projection further comprises comparing the identified screen classification with a set of non-flagged classifications, and the step of interrupting may comprise interrupting the provision of the screen projection if the identified screen classification is comprised in the set of flagged classifications and is not comprised in the set of non-flagged classifications.

The method may further comprise determining a set of projection parameters for the screen projection.

The step of identifying may be carried out on at least a portion of the screen projection.

The step of identifying may be carried out on the entirety of the screen projection

The step of identifying a screen classification may comprise:
deriving at least one probability of a screen frame having at least one of a plurality of possible screen classifications;
selecting the one of the plurality of possible screen classifications having the highest probability value as the identified screen classification.

The step of analysing the screen projection may comprise:
identifying at least a portion of a screen feature in the screen projection; and
comparing the identified image feature with a set of flagged features.

The step of identifying a screen feature may comprise:
detecting a potential screen feature in the screen projection;
deriving a first probability of the potential screen feature being identical to at least one of a first plurality of screen features by using a first identification mechanism; and
selecting the one of the first plurality of screen features having the highest probability value as the identified screen feature.

Interrupting the provision of the screen projection if flagged content is detected may comprise unregistering the image capture component. Interrupting the provision of the screen projection if flagged content is detected may comprise locking the device and terminating at least one background process running on the device. Interrupting the provision of the screen projection if flagged content is detected may comprise locking the device and terminating all background process running on the device.

### BRIEF DESCRIPTION OF THE DRAWINGS

An embodiment of the invention will now be described, by way of example, with reference to the drawings, in which:

FIG. 1 schematically illustrates an exemplary user device;

FIG. 2 shows an exemplary method in accordance with a first embodiment of the invention;

FIG. 3 schematically illustrates the method of FIG. 2;

FIG. 4 shows a first exemplary step of the method of FIG. 2;

FIG. 5 shows a second exemplary step of the method of FIG. 2;

FIG. 6 shows an exemplary step of the method of FIG. 4; and

FIG. 7 shows an exemplary step of the method of FIG. 5.

### DESCRIPTION OF THE PREFERRED EMBODIMENTS

Before describing the exemplary embodiments of the invention, it may be illustrative to describe an exemplary environment in which the exemplary embodiments may be implemented. It will, of course, be appreciated that the following environment is exemplary only, and not intended to be limiting. Other environments, comprising alternative or additional components, may easily be envisaged.

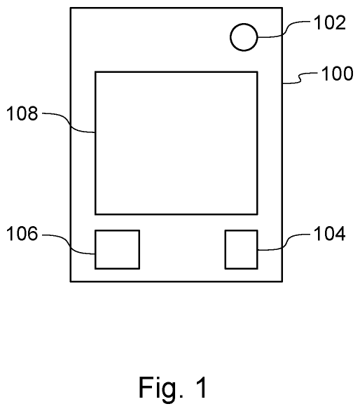

FIG. 1 schematically illustrates a user device 100 (e.g., a mobile phone, tablet device, personal computer, camera or other electronic device). The user device comprises an image capture component 102, a central processing unit 104, a memory element 106 and a display component 108. It will be appreciated that the user device may comprise additional components which, for purposes of conciseness and ease of explanation only, are not shown in FIG. 1. Such components include (without limitation): communication components (e.g., wireless transceivers); illumination components, control/interaction components or components providing additional functionality (e.g., GPS or NFC components).

The image capture component 102 may comprise any suitable elements or features. In some examples, the image capture component is a camera component comprising at least one image capture element and an imaging element (e.g., one or lenses, prisms, gratings or other optical components). In other examples, the image capture component is a component that is connected to a camera component, including (but not limited to) a camera control application; a remote connection component that is connected to a remote camera component; a software application associated with handling of input provided by a camera component; or software application associated with handling of input provided by a second software application connected with a camera component. In an example, the image capture component is a software application that interfaces with a camera component. In other examples, the image capture component is operable to receive at least one input frame from an image providing component, which may be located remotely from the user device.

It will be appreciated that the above examples are not mutually exclusive and can effectively be combined. A given user device may effectively comprise a plurality of the above-mentioned image capture components. For example, a user device may comprise a primary image capture component on one side as well as a secondary image capture component on the opposite side. Numerous configurations of image capture components are well known and will be obvious to the skilled person.

The image capture component may comprise a number of additional elements or components, such as processing or frame conversion components. In some instances, raw image data is processed and converted prior to being transmitted to other components in the user device. The conversion, in some examples, comprises operations such as cropping or resizing so that the image frame fits onto a display component. In other examples, the conversion comprises operations such as colour filtering, anti-aliasing, dithering or other filtering methods.

In some examples, the display component 108 is a display screen. In some examples, the display component may be a viewfinder (e.g., as may be found on a digital camera). In some examples, the user device comprises a plurality of display components. During use, the display component will typically be operable as a viewfinder to the image capture component, displaying objects currently being imaged by the image capture component.

In a manner similar to that of the image capture component described above, the display component may comprise a number of additional elements or components, such as processing or frame conversion components. In some instances, raw image data may be received from an image capture component, which may require processing and/or conversion prior to being displayed by the display component. The conversion, in some examples, comprises operations such as cropping or resizing so that the image frame fits onto a display component. In other examples, the conversion comprises operations such as colour filtering, anti-aliasing, dithering or other filtering methods.

It will be appreciated that the processing components described in respect of the image capture component and the display component may perform substantially similar functions. In some examples, the processing component may be implemented as a separate component that is accessed by either or both of the image capture component or display component. In some examples, both of the processing components may both be implemented, but only one be in use at any time.

Generally, hardware components on user devices are managed and/or controlled by relevant control applications. These control applications, in some examples, form part of the operating system of the mobile device. In other examples, they are separate from the operating system but directly controlled thereby. It will be appreciated that there are a number of ways in which the hardware of a mobile device can be integrated with and controlled by the operating system and software applications on a mobile device. Purely for conciseness purposes, when reference is made to a component of the user device in the following, this should be read as referring to both the hardware component itself, as well as to any controlling or otherwise relevant software components or elements.

User devices (e.g., mobile phones, tablets, digital cameras or laptop computers) are in common usage and are one of the most common devices for capturing images and/or video clips. Given the ubiquity of such devices, it is inevitable that some users capture images with private or adult content, whether intentionally or not. For example, some users may capture images of other persons in a state of partial or complete nudity. In some cases, such images may have the consent of the other persons, but in other instances the user does not seek consent before capturing the images. In other cases, obtaining such images may, itself, be unlawful or contrary to morality (e.g., if the third person is a minor).

Due to their nature, images containing nudity or other explicit or potentially compromising material can be used for a number of illegal or morally questionable purposes. Examples, of this include revenge pornography (also referred to more generally as ‘image-based sexual abuse’), online abuse or shaming, sexting, up skirting, or downblousing. Given the high mobility and typical small size of user device, use of such devices for illegitimate, unlawful or illegal purposes is common. There is, therefore, a need to limit or prevent capture and distribution of images with illegal or questionable content.

Furthermore, once images with illegal or questionable content are acquired, it is difficult for a person (e.g., a victim of revenge pornography or upskirting) to limit or prevent distribution of such images. The inventor has realised that an effective method for prevention of capture and distribution of questionable imagery is by preventing such images from being captured or acquired in the first place. However, the inventor has further realised that there is a need for preventing or limiting further distribution of such images once they are acquired.

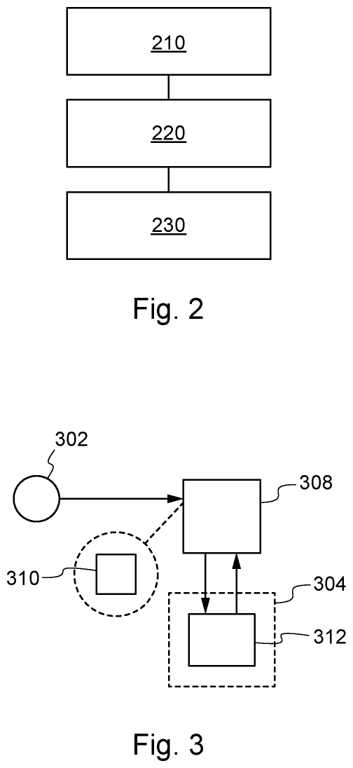

A first exemplary method in accordance with the present invention will now be described with reference to FIG. 2 and FIG. 3. The method may, for example be implemented in a user device comprising an image capture component and a display component (such as described with reference to FIG. 1). For ease of comparison with FIG. 1, elements of FIG. 3 similar to corresponding elements of FIG. 1 are labelled with reference signs similar to those used in this Figure, but with prefix “3” instead of “1”.

In a first step 210, a screen projection 310 of at least a first image frame captured by the image capture component 302 is provided to the display component 308.

In the present disclosure, the screen projection refers to the imagery or image-related data that is received, processed (if applicable) and displayed by the display component. The screen projection may, in some examples, be identical to raw images or media acquired by the image capture component. In other examples, the image capture component performs one or more pre-processing steps. In yet other examples, the display component performs one or more pre-processing or post-processing steps.

The screen projection may comprise any suitable image or media content received by the display component. The screen projection, in some examples, comprises an image or other media file. For example, the screen projection may be the most recent image received by the display component. Specifically, once the exemplary method is initialised, the most recent image received by the display component is used as the screen projection.

It will be appreciated that there are a number of methodologies and specific implementations available for a screen projection to be provided to a display component. It will further be appreciated that at least some of these are dependent on the specific properties one or more of the user device, the software applications installed or running thereon, or the properties of the operation system installed on the user device. In some examples, a software application for acquiring and displaying images (e.g., a camera app) calls or otherwise activates the image capture component and the display component.

In a second step 220, the screen projection is analysed to detect the presence of flagged content. The step of analysing may be carried out in any suitable fashion by a suitable unit or component.

Typically, the step of analysing is carried out by way of a suitable analysis component 312 or application installed or otherwise running on the user device. The analysis component may itself be run on any suitable hardware, including (without limitation) a central processing unit 304 of the user device, an image processing unit (e.g., a GPU) or a processing unit external to the user device.

The step of analysing may be implemented in a suitable fashion, using a suitable algorithm, methodology, process or sequence. In some examples, the step of analysing comprises a plurality of algorithms, methodologies, processes or sequences. Examples of methodologies that could be used in the analysis step include, but are by no means limited to): shape detection; colour detection; feature detection; feature classification; or frame classification. It will also be appreciated that a number of known analysis methodologies exist, including (without limitation): MobileNet, Alex Net, TensorFlow; TensorFlow Lite Classify; or TensorFlow Lite Detect. A number of specific examples of steps of analysing will be described in more detail in the following.

The specific analysis performed on the screen projection may, in some examples, depend on the properties, characteristics or parameters of the screen projection. For example, some screen projections may be encoded or formatted with a specific format or file type. Exemplary encodings or file formats include (but are by no means limited to): proprietary or non-proprietary raw image formats TIFF; PNG; JPEG; DNG; MOV or other move files. The screen projection may be encoded or formatted with the same format as the at least first image frame.

The analysis may be carried out on any relevant portion of the screen projection. In some examples, the analysis is performed on substantially the entirety of the screen projection. Depending on the format of the screen projection, it may be broken down into a plurality of portions or sub-sections, each of these portions or sub-sections being associated with or representing one or more specific characteristics, parameters or properties of the screen projection. In some examples, the characteristics, parameters or properties include (without limitation): colour space (e.g., CMYK, RGB, YUV, HSB, HSL, YIQ or TSL); or file-specific divisions (e.g., so-called ‘layers’). In other examples, the screen projection format may be of a specific type in which the content is progressively rendered, loaded or updated. In such examples, the analysis may be performed on the screen projection in any relevant or suitable stage of rendering, loading or updating.

It will, of course, be appreciated that a number of specific analysis methodologies may be employed to perform feature or objection detection within the screen projection. In some examples, as described above, the specific methodology may depend on the properties or characteristics of one or more of: the at least one input frame; the image capture component; the central processing unit, the display component or the image analysis component. A number of exemplary analysis methodologies will be described in more detail in the following.

In a third step 230, the provision of the screen projection 310 is interrupted if flagged content is detected.

The provision of the screen projection may be interrupted in any suitable fashion. In an example, operation of the image capture component is interrupted or otherwise halted. In another example, the data stream from the image capture component to the recipient component (e.g., the display component) is interrupted or halted. In some instances, the interruption is temporary (e.g., halting operation for a specific period of time). In other instances, the interruption is permanent (i.e., requiring a restart or re-initialisation of the relevant component or device).

In a specific example, the image capture component is unregistered. Unregistering a particular component or process causes the application to lose access to this component or process. Typically, this requires the application to be restarted in order to access the component or process. As the unregistration is normally a higher administrative level than a standard user level, a user cannot typically prevent unregistration from occurring or otherwise interfere therewith.

In another example, the user device is locked and at least one background process running on the user device is terminated if flagged content is detected. In a specific example, the user device is locked and all background processes are terminated. By locking the device, the user is prevented from taking any actions, such as photographing or otherwise obtaining flagged or illegal content or distributing flagged or illegal content. However, since user devices (and computing devices generally) commonly run background processes, which may not be interrupted when the user device is locked, it is potentially necessary to terminate one or more background processes to ensure that the user (or any applications or processes run by said user) does not carry out any actions involving flagged or illegal content. In some instances, it may be sufficient to interrupt a specific background process. However, it may be safer in certain circumstances to terminate or interrupt all background processes. In certain circumstances, wherein background processes relate to one or more components, the components can be unregistered in a manner similar to that described above.

The above exemplary interruption steps are purely exemplary. On detection of flagged content, alternative or additional actions may be carried out, including (but not limited to): locking the user device, in order to prevent the user from carrying out further actions; locking the user device and terminating a software application; redirecting the user to a second software application; blocking functionality of or user access to one or more user interface (UI) components; blocking functionality of one or more hardware-implemented components of the user device (e.g., hardware buttons located on the exterior of the user device); or blocking screenshot acquisition functionality of the user device. It will be appreciated that, in some circumstances, a plurality of the above-mentioned actions is carried.

The above method, when implemented on a user device, can either be a constantly running process or it can be a process that is triggered based on one or more of a set of specific circumstances. In either case, the method is typically implemented as an administrator or other higher level process within the user device. This prevents standard users from interrupting, circumventing or otherwise interfering with the operation of the method.

When implemented as a constantly running process, the exemplary method continuously monitors operations of the user device. Given that the method is constantly running, any time delay between the start of provision of a screen projection and initialisation of the method is minimised. This reduces the delay before a processing result is obtained, which reduces the delay between initialisation of the process and a potential interruption. This, in turn reduces the risk that any undesirable content or imagery is captured and viewed.

In some examples, wherein the exemplary method continuously monitors operations of the user device, the method comprises an additional step of determining whether the image capture component is active. This step can be performed before, in parallel with, or subsequently to the step of analysing. By determining whether the image capture component is active before carrying out the step of interrupting, it can be verified whether any content on the display component originates from the image capture component. Under certain circumstances, a user may be viewing content on the display component that would, if obtained by way of the image capture component, be identified as flagged content. For example, a user could legally be looking at adult content through a software application that does not relate to use of the image capture component (e.g., browsing pornographic materials).

When implemented as a process that is triggered based on one or more of a set of specific circumstances, the overall processing burden of the exemplary method on the user device is reduced. This may be particularly relevant for user devices with less processing power or memory. Additionally, by triggering the exemplary method only when required or advantageous, the risk of false negatives or false positives being identified is reduced significantly.

Any suitable set of specific circumstances may be employed to trigger the exemplary method. In some examples, the exemplary method is triggered when any app that is permitted to utilise the image capture component is run, enabled or otherwise activated. In an example, the exemplary method is triggered when the image capture component is determined to be unavailable (i.e., when the image capture component is in use). When the image capture component is in use by a software application, availability of this component is removed. As such, by determining the availability status of the image capture component, it can be determined whether the camera is in use.

In the above, the step of analysing of the exemplary method has been described in a general sense. It will be appreciated that a number of implementations of the step of analysing may be envisaged within the scope of the present disclosure. I will also be appreciated that, whilst the step of analysing has been described as a single step in the above, this is for purely exemplary purposes. As discussed, the step of analysing may be comprised of a plurality of individual methodology or process steps (e.g., each of which using different analysis methodologies). Furthermore, even if comprising only a single process or methodology, the analysis step may be comprised of a plurality of discrete analysis steps. A number of purely exemplary implementations of analysis steps will now be described.

A first exemplary step of analysing will now be described with reference to FIG. 4. For ease of comparison with FIG. 2, elements of FIG. 4 similar to corresponding elements of FIG. 2 are labelled with reference signs similar to those used in this Figure, but with prefix “4” instead of “2”.

In the present example, the analysis step comprises a first analysis step 421 of identifying a screen classification of the screen projection. The classification may be identified in any suitable fashion.

In one example, the step of identifying a screen classification comprises categorising at least a portion of the screen projection into at least one of a plurality of possible screen classifications. The possible screen classifications may, in some examples, comprise pre-determined classifications or categories. In other examples, the possible screen classifications comprise dynamically generated classifications or categories. In yet other examples, the possible screen classifications comprise both pre-determined and dynamically generated classifications or categories. An exemplary classification methodology will be described in more detail below.

The step of identifying may be carried out on any suitable portion of the screen projection. As described above, the step of identifying is, in some examples, carried out on only a portion of the screen projection. This may save on processing resources. In other examples, the step of identifying is carried out on the entirety of the screen portion. Whilst this requires more resources than carrying out the step of identifying on only a portion of the screen projection, it also reduces the risk of flagged content being detected.

In the present example, the step of analysing further comprises a second analysis step 422 of comparing the identified classification with a set of flagged classifications. The step of comparing may be carried out in a suitable fashion. In some examples, the identified frame classification is compared with a set of flagged classifications.

The set of flagged classifications used in the step of comparing may be obtained from any suitable source and may be implemented in any suitable manner. In some examples, the set of flagged classifications is implemented as an integral part of the software application. In some examples, the set of flagged classifications is stored in the memory of the user device separately from the software application. In an example, the set of flagged classifications is implemented as a single file (e.g., a “text” file or other list). In other examples, the set of flagged classifications is stored remotely from the user device. In other examples, set of flagged classifications is stored on a central server, but is transmitted to the mobile device prior to the comparison step, e.g., in response to a transmission request transmitted by the user device to the server.

In some examples, the step of analysing further comprises a third analysis step 423 of comparing the identified screen classification with a set of non-flagged classification. In such examples, the step of interrupting comprises interrupting the provision of the screen projection if the identified screen classification is comprised in the set of flagged classifications and is not comprised in the set of non-flagged classifications. The set of non-flagged classifications may contain any suitable content that is verified as non-flagged. In some instances, certain objects, colours or features of objects (e.g., human faces) can occasionally be incorrectly identified as flagged content. This increases the risk that provision of the screen projection is incorrectly interrupted, which unduly reduces the functionality of the user device and negatively impacts the user experience. In certain instances, it may prevent legitimate and lawful usage of the user device.

In some examples, the step of analysing further comprises a fourth analysis step 424 of determining a set of projection parameters for the screen projection. In some examples, the step of determining comprises processing the screen projection in a suitable manner dependent on the determined projection parameters. In some instances, this comprises cropping, resizing, stretching, filtering or otherwise transforming the screen projection. For example, processing may involve resizing the screen projection to fit or optimise a specific analysis methodology. In some examples, the third analysis step is carried out prior to the identifying step and/or the comparison step, although, third analysis step could, in principle, equally well be performed subsequently to either or both of these steps.

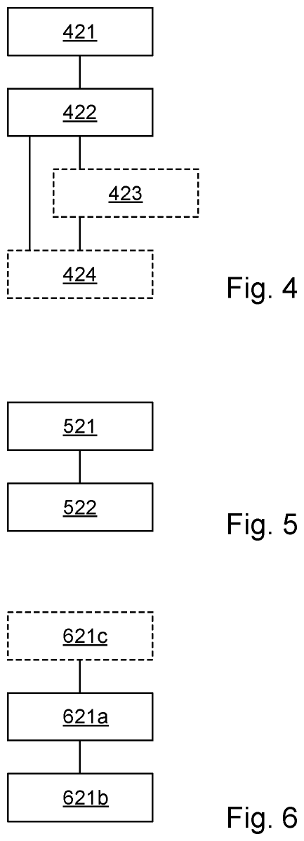

A second exemplary step of analysing will now be described with reference to FIG. 5. For ease of comparison with FIG. 4, elements of FIG. 5 similar to corresponding elements of FIG. 4 are labelled with reference signs similar to those used in this Figure, but with prefix “5” instead of “4”.

In the present example, the step of analysing comprises a first analysis step 521 of identifying at least a portion of a screen feature in the screen projection. The image feature, or a portion thereof, may be identified in a suitable manner by way of a suitable algorithm or other mechanism. It will be appreciated that a number of suitable methodologies exist for this purpose that may be used in the present exemplary method.

By utilising feature detection, it is possible to allow for the presence of multiple bodies within a single screen projection. Additionally, it is possible to detect a plurality of features (as for example opposed to an overall screen classification) within the screen projection. For example, it is possible to detect the simultaneous presence of several different body features (e.g., nipples and genitalia). By contrast, if using only a classification for a screen projection containing several different body features, there is a risk of misclassification or a risk that only one classification is applied.

The step of analysing further comprises a second analysis step 522 of comparing the identified image feature with a set of flagged features. The comparison may be carried out in a suitable manner.

The set of flagged content used in the step of comparing may be obtained from any suitable source and may be implemented in any suitable manner. In some examples, the set of flagged features is implemented as an integral part of the software application. In some examples, the set of flagged features is stored in a memory of the user device separately from the software application. In an example, the set of flagged features is implemented as a single file *(e.g., a “text” file or other list). In some examples, the set of flagged content is stored in the memory of the mobile device. In other examples, the set of flagged content is stored remotely from the mobile device. In other examples, set of flagged content is stored on a central server, but is transmitted to the mobile device prior to the comparison step, e.g., in response to a transmission request transmitted by the mobile device to the server.

Both of the above examples describe an analysis step utilising a single analysis methodology. As discussed further above, however, in some instances it may be advantageous or preferable to use both the above analysis methodologies. This can be implemented in any suitable fashion. In some instances, the first analysis methodology and the second analysis methodology may be processed in parallel. In other instances, the first analysis methodology is processed first and the second analysis methodology is processed secondly. In yet other instances, the methodologies are processed in reverse order.

As described above, the skilled person may envisage a number of specific classification methodologies within the scope of the present disclosure. One exemplary identifying step, such as could for example be used in the method described above with respect to FIG. 4, will now be described with reference to FIG. 6. For ease of comparison with preceding Figures, elements of FIG. 6 similar to corresponding elements of the preceding Figures are labelled with reference signs similar to those used in these respective Figures, but with prefix “6”.

In a first analysis step 621a, at least one probability of a screen frame having at least one of a plurality of possible screen classifications is derived. Any suitable portion of the screen projection may be selected and/or used for purposes of the derivation. In some examples, a suitable portion of the screen frame may be pre-selected prior to the derivation analysis step. In an example, the analysis step comprises an optional portion detection analysis step 621c.

In some examples, the size and/or position of the suitable portion is determined and selected on a case by case basis. In other examples, the suitable portion has a fixed size and/or position. In some examples, substantially the entirety of the screen projection is used in the derivation step. In some examples, the entirety of the screen projection is subjected to a modification, reduction or decomposition step prior to the derivation being carried out. By ensuring that the derivation step is performed only on a relevant portion of a screen projection or on a modified, reduced or decomposed screen projection, the use of system or processing resources in the mobile device can be optimised. This may reduce the time required to process individual screen projections.

Any suitable number of probabilities of the screen projection having at least one of the plurality of possible screen classifications may be derived. In some examples, a single possible screen classification is derived. This keeps the required processing or system resources to a minimum. In other examples, a plurality of possible screen classifications are derived. Whilst this requires additional processing or system resources, it may be advantageous or necessary for a number of reasons (some of which will be discussed in more detail below).

The specific number of probabilities derived in the derivation step may be dependent on a number of factors, including (without limitation): available processing power, available memory, transmission speed, one or more possible image classifications or input frame characteristics. Deriving a plurality of probabilities may be an advantage in some circumstances, for example in circumstances wherein a particular portion of an input frame could be categorised in several classifications. This can, for example, be due to the quality of the input frame or due to limitations in the identification methodology or in the associated data (e.g., training data). In some instances, it may be a combination of several of the above factors.

The first plurality of possible screen classifications may be comprised in a screen classification database. The screen classification database may be implemented in any suitable manner. In some examples, the screen classification database is formed as part of an executable file of the software application. In some examples, the screen classification database is formed as a non-executable file distributed with the software application. In an exemplar, the screen classification database is formed as a “text” file or other similar file type. In some examples, the screen classification database comprises image classifications associated with flagged classifications. In some examples, the database comprises screen classifications associated with flagged content and non-flagged content.

The screen classification database may be compiled in any one of a number of suitable or convenient manners. In some examples, the database comprises screen classifications that have been identified and catalogued by one or more users. In some examples, the database comprises screen classifications that have been identified and catalogued by one or more automated algorithms (e.g., by way of one or more machine learning algorithms). In other examples, the database comprises screen classifications identified and catalogued in both of the above ways. It will be appreciated that there are many ways in which a database for use with the present methods may be compiled.

The derivation step may be performed in any suitable fashion and using any suitable derivation methodology, including (but not limited to): TensorFlow Lite Classify; or TensorFlow Lite Detect.

In a second analysis step 621b, at least one of the plurality of possible screen classifications having the highest probability value is selected as the identified screen classification. It is to be noted that this selecting analysis step is described purely for exemplary purposes, and that other selection criteria may equally well be implemented or applied.

In an example, once the probabilities for each of the plurality of possible screen classifications have been derived, a sub-set of the plurality of possible screen classifications having the highest probabilities are evaluated. In an example, the possible screen classifications having the highest 3, 4, 5 or 6 probabilities are evaluated. If some or all of these probabilities relate to flagged content, a general flagged content classification is selected as the identified screen classification.

In a manner similar to that described above, it will be appreciated that, in some examples, one or both of the first 621a or second 621b analysis steps may comprise one or more additional operations that are carried out on at least part of the screen projection, the one or more additional operations being operable to increase the likelihood of either or both of the step of detecting or the step of deriving being successfully completed. In some examples, wherein the screen projection is modified as described above, it may be determined that, upon completion of any necessary additional operations on the screen projection, the additional operations have not successfully increased the likelihood of either or both of the first or second sub-steps being successfully completed. In order to mitigate such circumstances, in some examples, the identifying step comprises an additional sub-step of ignoring the screen projection and to select at least one of a preceding or subsequent screen projection to be used in the method.

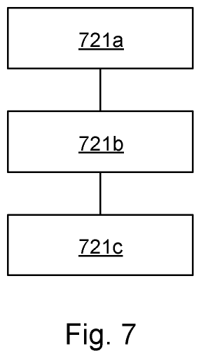

As described above, the skilled person may envisage a number of specific feature detection methodologies within the scope of the present disclosure. One exemplary identifying step, such as could for example be used in the method described above with respect to FIG. 5, will now be described with reference to FIG. 7. For ease of comparison with preceding Figures, elements of FIG. 7 similar to corresponding elements of the preceding Figures are labelled with reference signs similar to those used in these respective Figures, but with prefix “7”.

In the present example, the step of identifying comprises a first analysis step 721a of detecting a potential screen feature in the screen projection. Any suitable portion of the screen projection may be selected and/or used for purposes of detection. Any suitable number of potential screen features may be detected.

The step of identifying further comprises a second analysis step 721b of deriving a probability of the potential screen feature being identical to at least one of a first plurality of screen features by using a first identification mechanism.

The step of identifying further comprises a third analysis step 721c of selecting the one of the first plurality of screen features having the highest probability value as the identified screen feature.

Whilst only a single probability is mentioned in the present example, it is, in principle to derive a plurality of first probabilities, each probability in the plurality of first probabilities corresponding to a particular possible screen feature. The derivation step may return any suitable or advantageous number of probabilities and/or respective possible screen features. In an example, the derivation step returns two possible screen features including the respective probabilities. In another example, the derivation step returns three screen features as well as their respective probabilities. In another example, the derivation step returns four possible screen features as well as their respective probabilities. In yet another example, the derivation step returns five possible screen features as well as their respective probabilities.

The specific number of probabilities derived in the derivation step may be dependent on a number of factors, including (without limitation): available processing power, available memory, transmission speed, one or more possible image classifications or input frame characteristics. Deriving a plurality of probabilities may be an advantage in some circumstances, for example in circumstances wherein a particular portion of an input frame could be categorised in several classifications. This can, for example, be due to the quality of the input frame or due to limitations in the identification methodology or in the associated data (e.g., training data). In some instances, it may be a combination of several of the above factors.

Purely by way of example, an input frame might depict a third person in a state of partial or full nudity. Simultaneously, the input frame may be imaged under less than ideal circumstances (e.g., at low light levels or at camera settings not suited to the surroundings). Further, the input frame may only show portions of the third person, which may render the positive identification of specific features more difficult. By deriving a plurality of probabilities, the probability of determining whether an screen projection contains flaggable content increases. Whilst it may, for example, be difficult to determine whether a given feature is an arm, a leg or a different part of a third person's body, which would result in low probabilities being returned for specific bodily features, the probability of the feature being ‘exposed skin’ may be significantly higher. In such a case, it may be reasonable to assume that the screen projection depicts nudity, which may constitute flaggable content, even if the specific body part may not be positively identifiable.

The probability may be derived in any suitable fashion using a suitable probability deriving mechanism. The probability deriving mechanism may comprise any suitable number or type of identification algorithms or processes. The first plurality of possible screen features may be comprised in a screen feature database. In some examples, the screen feature database comprises screen features associated with flagged content. In some examples, the database comprises screen features associated with flagged content and non flagged content.

The screen feature database may be compiled in any suitable or convenient manner. In some examples, the database comprises image features that have been identified and catalogued by one or more users. In some examples, the database comprises image features that have been identified and catalogued by one or more automated algorithms (e.g., by way of one or more machine learning algorithms). In other examples, the database comprises images features identified and catalogued in both of the above ways. It will be appreciated that there are many ways in which a database for use with the present method may be compiled.

It will be appreciated that the above-described exemplary methods, whilst discussed in isolation, may be performed as part of a larger method or set of methods. In some examples, the method is implemented as a stand-alone software application activated by a user or administrator of the user device. In other examples, the method is implemented as an integral part of a software application and is launched without the involvement of the user or an administrator of the user device. In yet other examples, the method is implemented as part of a library, module or other framework module forming part of a platform.

Various embodiments are described herein with reference to block diagrams or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory, computer-readable medium may include an electronic, magnetic, optical, electromagnetic, or semiconductor data storage system, apparatus or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM) or a portable digital versatile/video disc read-only memory (DVD/Blu-ray).

The computer program instructions may also be loaded onto a computer and/or other programmable data processing apparatus to cause a series of operational steps to be performed on the computer and/or other programmable data processing apparatus to cause a series of operational steps to be performed on the computer an/or other programmable apparatus to produce a computer-implemented process such that the instructions which execute on the computer or other programmable apparatus provide steps for implementing the functions/acts specified in the block diagrams and/or flowchart block or blocks.

Accordingly, the invention may be embodied in hardware and/or in software (including firmware, resident software, micro-code etc.) that runs on a processor, which may collectively be referred to as “circuitry”, “a module” or variants thereof.

It should also be noted that in some alternate implementations, the functions/acts noted in the blocks may occur out of the order noted in the flowcharts. For examples, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein and without limitation to the scope of the claims. The applicant indicates that aspects of the invention may consist of any such individual feature or combination of features. In view of the foregoing description it will be evident to a person skilled in the art that various modifications may be made within the scope of the invention.

While specific embodiments of the invention have been described above, it will be appreciated that an embodiment of the invention may be practiced otherwise than as described. For example, an embodiment of the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

1. A method for identifying and preventing display of flagged content on a user device, the user device having an image capture component and a display component, the method comprising:
providing a screen projection of at least a first image frame captured by the image capture component to the display component;
analysing the screen projection to detect the presence of flagged content; and
interrupting the provision of the screen projection if flagged content is detected.

2. A method according to claim 1, wherein the step of analysing the screen projection comprises:
identifying a screen classification of the screen projection; and
comparing the identified screen classification with a set of flagged classifications.

3. A method according to claim 2, wherein:
the step of analysing the screen projection further comprises comparing the identified screen classification with a set of non-flagged classifications; and
the step of interrupting comprises interrupting the provision of the screen projection if the identified screen classification is comprised in the set of flagged classifications and is not comprised in the set of non-flagged classifications.

4. A method according to claim 2, further comprising:
determining a set of projection parameters for the screen projection.

5. The method according to claim 2, wherein the step of identifying is carried out on at least a portion of the screen projection.

6. The method according to claim 5, wherein the step of identifying is carried out on the entirety of the screen projection.

7. The method according to claim 2, wherein the step of identifying a screen classification comprises:
deriving at least one probability of a screen projection having at least one of a plurality of possible screen classifications; and
selecting the one of the plurality of possible screen classifications having the highest probability value as the identified screen classification.

8. The method according to claim 1, wherein the step of analysing the screen projection comprises:
identifying at least a portion of a screen feature in the screen projection; and
comparing the identified image feature with a set of flagged features.

9. The method of claim 8, wherein the step of identifying a screen feature comprises:
detecting a potential screen feature in the screen projection;
deriving a first probability of the potential screen feature being identical to at least one of a first plurality of screen features by using a first identification mechanism; and
selecting the one of the first plurality of screen features having the highest probability value as the identified screen feature.

10. A method according to claim 1, wherein interrupting the provision of the screen projection if flagged content is detected comprises unregistering the image capture component.

11. A method according to claim 1, wherein interrupting the provision of the screen projection if flagged content is detected comprises locking the device and terminating at least one background process running on the device.

12. A method according to claim 11, comprising terminating all background processes running on the devices.

13. A user device comprising means for performing the method of claim 1.

14. A computing device comprising means for performing the method of claim 1.

15. A computer system comprising a plurality of computing devices, wherein the plurality of computing devices each comprise means for performing at least part of the method of claim 1.

16. A user device configured to perform the method of claim 1.

17. A computing device configured to perform the method of claim 1.

18. A computer system comprising a plurality of computing devices, wherein each of the plurality of computing devices is configured to perform the method of claim 1.
